(19) United States
(12) Patent Application Publication
(10) Pub. No.: US 2003/0070179 A1
(43) Pub. Date: Apr. 10, 2003

(54) System and method for connecting end user with application based on broadcast code

(76) Inventors: Peter B. Ritz, Meadow brook, PA (US); Ola Carlvik, Walnut Creek, CA (US); Staffan Liljegren, St. Davids, PA (US)

Correspondence Address: Daniel H. Golub, 1701 Market Street, Philadelphia, PA, 19103, US

(21) Appl. No.: 10/047,540

(22) Filed: Jan. 15, 2002

Related U.S. Application Data
(63) Continuation-in-part of application No. 09/971,115, filed on Oct. 4, 2001.
(63) Continuation-in-part of application No. 09/971,321, filed on Oct. 4, 2001.
(63) Continuation-in-part of application No. 09/971,369, filed on Oct. 4, 2001.
(63) Continuation-in-part of application No. 09/971,093, filed on Oct. 4, 2001.

(51) Int. Cl. H04N 7/173; H04N 7/10

(52) U.S. Cl. 725/119; 725/110; 725/32

(57) ABSTRACT

An end user is connected to a content provider application relating to a broadcast visually or audibly observed by the end user. The broadcast may be adapted to include a code, may include a broadcast prompt associated with a code, or may simply be associated with a broadcaster that is associated with a code. Code information associated with the code that uniquely identifies a broadcast station is received at a hub site. Time date information corresponding to the time and date of the broadcast may also be received at the hub site. Based on the received code information and time date information, the application is identified. The end user is connected with the identified application.

### FIELD OF THE INVENTION

The invention relates generally to communicating information over a network and, more particularly, to connecting an end user with a content provider application based on code information obtained by the end user relating to a broadcast.

### BACKGROUND OF INVENTION

Today, a consumer's interaction with a television or radio broadcast is unidirectional. The consumer watches or listens to programs and advertisements and interprets the implied messages, but does not have the opportunity to respond to what he sees (e.g, ask questions, find out more, or simply engage). While the consumer may obtain additional information from a web site simply by knowing a product name or manufacturer, the consumer must typically perform some degree of searching to obtain information about the specific item in which the consumer is interested. Thus, obtaining additional information regarding a specific item of interest, if even achievable, is time consuming and involves multiple steps.

At the same time, those who provide content for the broadcasts, such as advertisers and media outlets, have no way of knowing that their broadcasted content has sparked an interest in a viewer or listener. These entities, furthermore, do not know which consumers are interested and which would like to receive more information, such as coupons, promotions, videos, interactive demos, or other content-specific information. Thus, there exists a need for an efficient way of locating information about an item of interest identified by a consumer while listening to the radio or watching television, as well as informing advertisers which consumers are interested in their products and services.

### SUMMARY OF THE INVENTION

The present invention is directed to a system and method for connecting at least one end user to a content provider application relating to a broadcast. The broadcast may be adapted to include a code, may include a broadcast prompt associated with a code, or may simply be associated with a broadcaster that is associated with a code. Within the system, a plurality of end users remotely access a network having at least a hub site and a content provider site. Code information associated with the code that uniquely identifies a broadcast station is received at the hub site. Time date information corresponding to the time and date of the broadcast may also be received at the hub site. Based on the received code information and, in some cases, the time date information, the application is identified. The end user is connected with the identified application.

### BRIEF DESCRIPTION OF THE DRAWINGS

FIG. 1A is an illustration depicting one preferred embodiment of a system of the present invention;

FIG. 1B is an exemplary registration web page that an end user may use to sign up for services offered in accordance with the present invention;

FIG. 2 illustrates a manner in which a database, or portion thereof, may be organized in accordance with one embodiment of the present invention;

FIG. 3 illustrates a manner in which a database, or portion thereof, may be organized in accordance with one embodiment of the present invention;

FIG. 4A illustrates a manner in which a database, or portion thereof, may be organized in accordance with one embodiment of the present invention;

FIG. 4B illustrates an exemplary registration web page that may be used by a media owner to register to have their applications accessible by ends users in accordance with a preferred embodiment of the inventive system;

FIG. 4C illustrates an exemplary web page that may be used by a media owner to associate an application with broadcast content;

FIGS. 5A through 5I illustrate some exemplary ways in which an end user may obtain code information corresponding to a broadcast;

FIGS. 6A through 6C illustrate user interfaces that may be presented to a user employing the inventive system;

FIGS. 7A through 7E illustrate user interfaces that may be presented to a user employing the inventive system;

FIG. 8 illustrates a user interface that may be presented to a media owner identifying end user tracking information; and

FIG. 9 is a flow chart illustrating a method of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

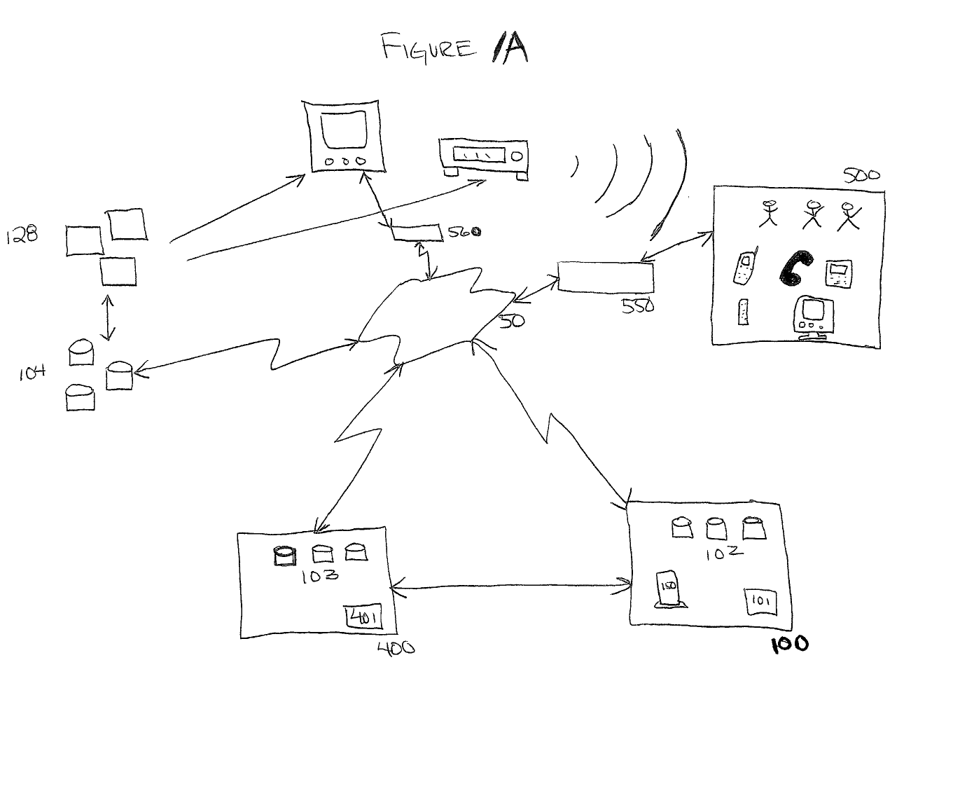

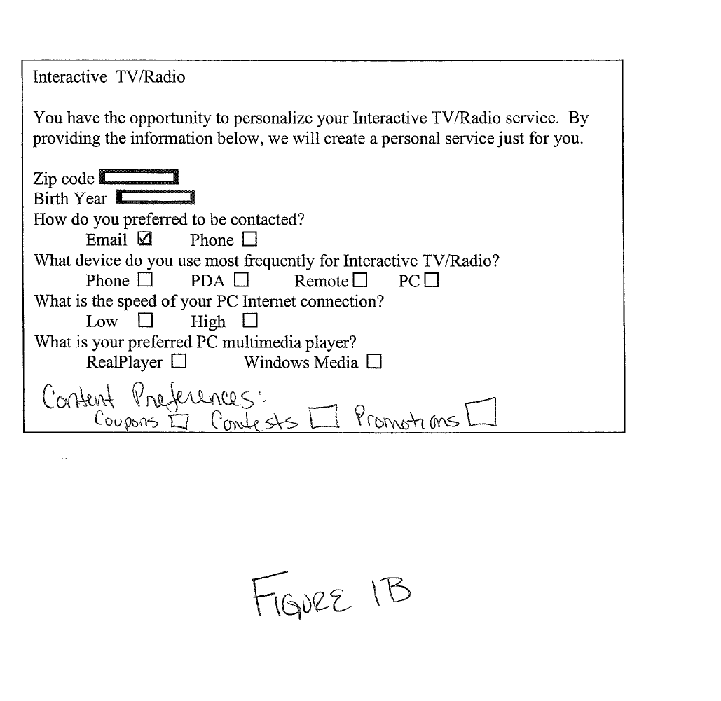

FIG. 1A illustrates a preferred embodiment of a system 1000 for carrying out the methods of the present invention. System 1000 includes a plurality of end users 500 as well as broadcasters 128. Broadcaster 128 may be a broadcaster of any video or audio signal, such as television or radio, which may include music, news, advertisements, images, sounds, or any other content that is capable of being broadcast. Broadcasters 128 may maintain one or more databases 104 that store programming sequence information. In other embodiments, such databases are maintained for broadcasters 128. End users 500 each maintain a device 501 (e.g., a telephone, mobile telephone, wireless or other personal digital assistant, or TV remote control with a time/date stamp feature and the ability to connect to an Internet enabled device, such as a personal computer) that allows the end user 500 to capture or otherwise input codes and other information (e.g., time date information) relating to a broadcast of broadcaster 128.

System 1000 also includes a platform 100, which includes one or more servers 150 and is accessible to end users 500 through a hub site 101 supported by platform 100. In the preferred embodiment, platform 100 is maintained and used by a service provider to, among other things, receive and store codes and time/date information; associate the codes and time/date information with applications; connect the end user 500 with the applications; and, in some embodiments, accept end user input related to the applications. In order to store and process codes, time/date information and applications associated with the codes, platform 100 includes one or more databases 102. In some embodiments, one or more third party content providers 400 may be employed to maintain one or more databases 103 to store such information and to perform one or more of the described functions of platform 100, in whole or in part. Third party content providers 400 may also maintain one or more content provider sites 401 for hosting applications. Accordingly, platform 100 may be a conduit through which end users 500 send and receive information to and from third party content provider 400 and through which end users 500 obtain access to applications of the third party content provider 400.

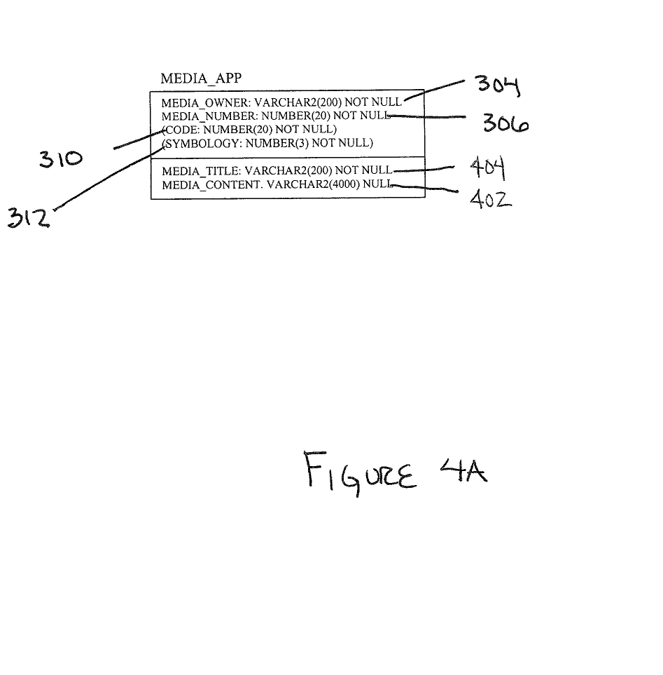

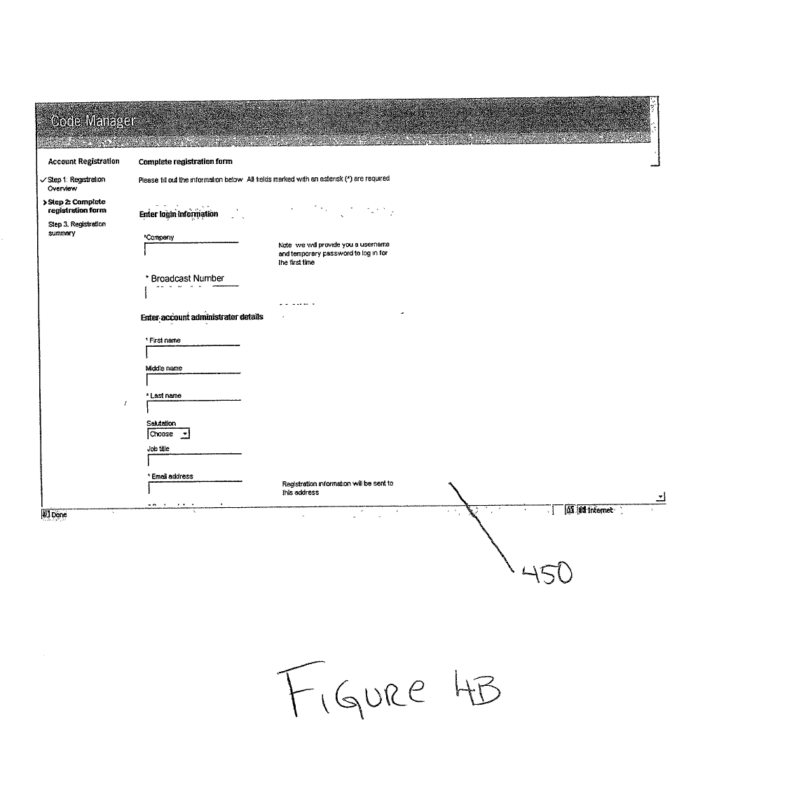

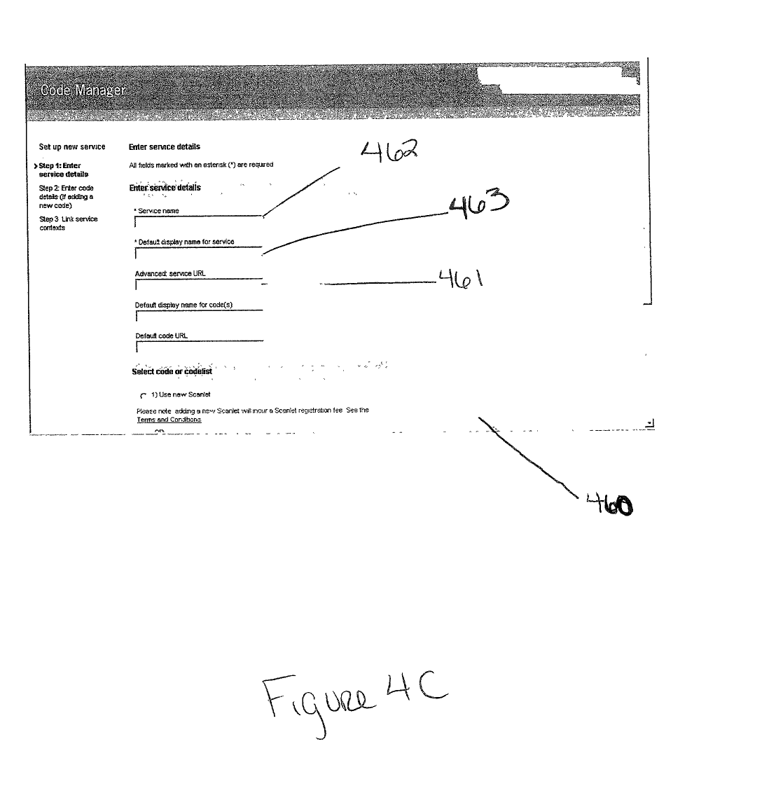

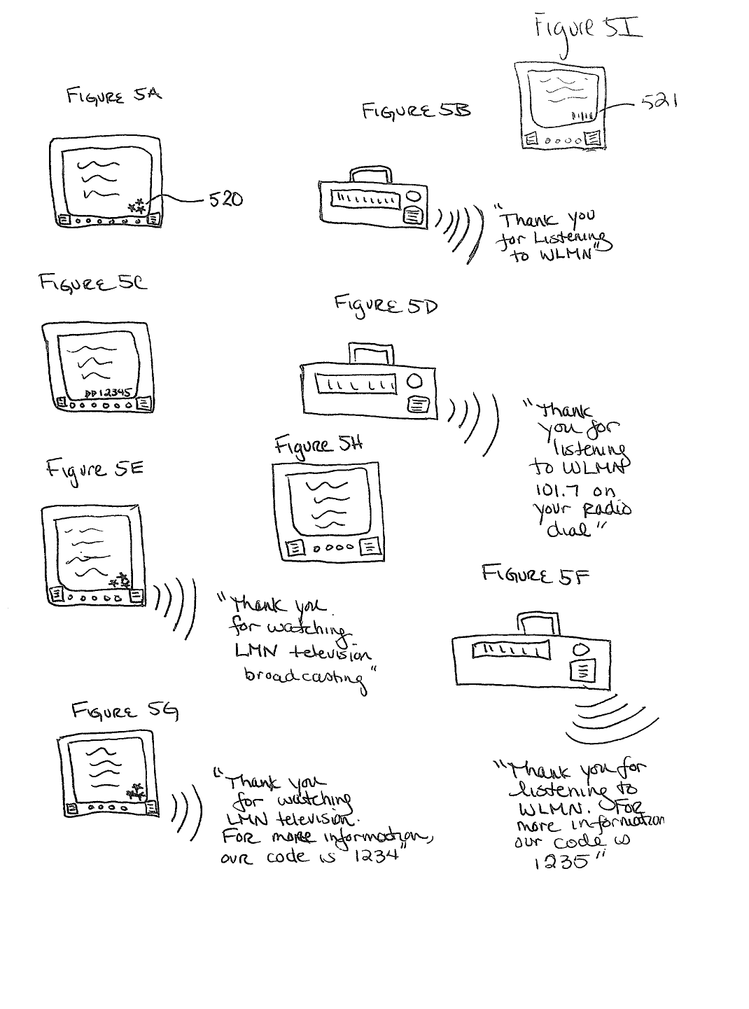

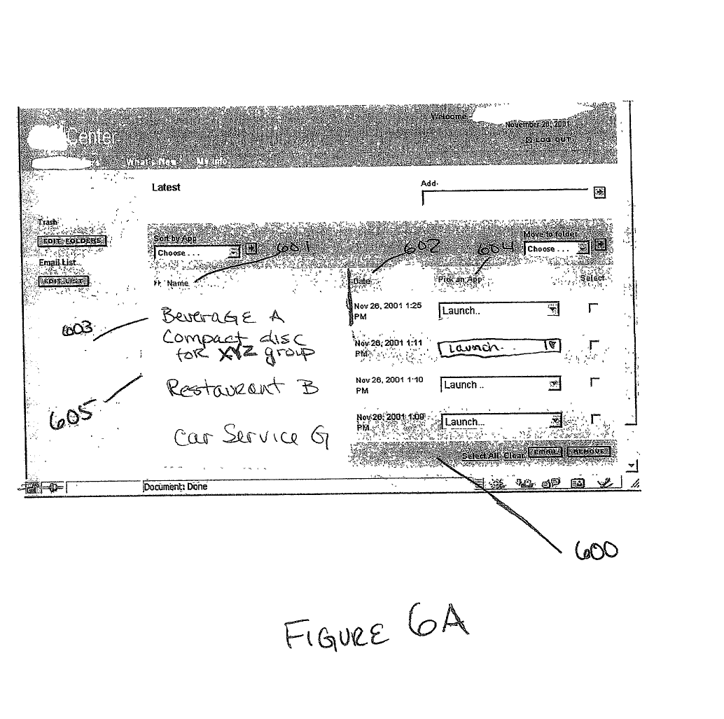

End users 500 receive visible, audible or machine detectable signals from broadcasters 128 through either the television, radio or other media outlets, as described in more detail with reference to FIGS. 5A through 5H. End users 500, platform 100 and the third party content providers 400 may connect to each other through a variety of different types of links to form a network. For example, end users 500 may connect to platform 100 through the Internet 50, as may platform 100 to third party content provider 400. Depending on the device used by end user 500, the communication from end user 500 to platform 100 or third party content provider 400 may be routed through one or more gateways 550. For example, for embodiments in which the end user inputs the code and time/date information by speaking the same into a telephone receiver, or dialing this data into the handset, the input is transmitted though a voice gateway to Internet 50 and then to a voice response unit at platform 100. By way of further example, end users 500 may also use a personal digital assistant 10 (or other wireless, Internet-enabled device) and transmit codes through a wireless application protocol gateway to Internet 50, and then to platform 100. In other embodiments, alternate configurations of the connections (which may or may not be wireless) among end users 500, platform 100 and third party content providers 400 are possible, will be known to those skilled in the art, and are within the scope of the present invention.

In some embodiments, the end user may register with a platform 100 to take advantage of the inventive system. With reference to FIG. 1B, an exemplary registration page is shown that can be used in embodiments where pre-registration is required. The system of the present invention, such as that described above, may be used to connect end users with an application related to an item of interest to the end user (e.g., a product, service, company, industry) that is identified by the end user while watching television or listening to the radio. The application may be, for example, additional information about the item, a coupon or promotion relating to the item, or an offer to perform some action with respect to the item (e.g., send information to a friend). Any type of application can be employed within the scope of the present invention.

In accordance with the present invention, upon the end user 500 identifying an item of interest during exposure to a television or radio broadcast, code information corresponding to a code that uniquely identifies the broadcast is submitted to server 150 on platform 100. In addition, information regarding the time and date the item of interest was broadcast is submitted to server 150. Based on the code and time date information, server 150 identifies the corresponding application and connects the end user 500 to the application. Connecting the end user 500 to the application can be achieved in any number of ways. By way of example, the application may be sent to the end user 500 in an e-mail, the end user 500 may be directed to a URL that points to a web page containing the application, or the user may be directed to a WAP page on a mobile device with a wireless Internet connection or receive a text message. Other ways of connecting the end user 500 with the identified application will be known to those skilled in the art and are within the scope of the present invention.

The end user 500 may obtain the codes and communicate the same to the platform 100 in a variety of ways using a number of different types of devices, all of which are within the scope of the present invention. For example, a code may be spoken aloud during the broadcast. By way of further example, the code may be displayed during a television broadcast. Alternatively, the actual code may not be displayed, but a prompt indicating the broadcast station may be displayed during a television broadcast. In this case, the end user may know or may be able to determine the code for the broadcast indicated by the prompt. For example, the logo of a television station may be displayed during the broadcast that is familiar to the user who also knows the code associated with that television station. In another example, the call letters of a radio station (e.g., WLMN) or the station number (1015), for which the user knows the accompanying code, may be broadcast. In any of these cases, the end user may manually enter the code into a device. The code may be transmitted to the platform 100 automatically upon entering the code into the device if the device is Internet-enabled with a live connection. Otherwise, the code may be transmitted upon connecting the device to the Internet or to an Internet-enabled device (e.g. a personal computer). In the case where an end user speaks the code into the phone, the code information would be transmitted automatically.

In the preferred embodiment, upon the end user inputting the code information (e.g., either by scanning, speaking, or keyboard/pad entry), the time date information is noted automatically by the device used to enter the code and transmitted to platform 100 along with the code. In other embodiments, the time date information is entered into a device manually by the end user. For example, the time date information entered for a particular broadcast occurring at 8:45 a.m. on Nov. 30, 2001, may be 084511302001. Alternatively, a device with a time date stamp (such as, e.g., a mobile telephone or personal digital assistant) may be used to record the time and date that the item of interest is broadcast. Other ways of identifying and manually entering the time date information will be known to those skilled in the art. The time date information is stored at platform 100 and associated with the corresponding inputted code information.

In some embodiments, the end user employs a telephone system with voice recognition to communicate the code and time/date information to the platform 100. In this embodiment, the end user places a telephone call and speaks the code information into the receiver. In the preferred embodiment, the time/date information is noted automatically and both the code and time/date information is automatically transmitted to platform 100.

In still other embodiments, the code is machine detectable, rather than or in addition to being visually or audibly detectable by the end user. In this case, the device automatically captures the machine detectable code from the broadcast. Methods for encoding the code in the broadcast and decoding the code captured on a device are known in the art, for example, as disclosed in U.S. Pat. Nos. 5,579,124; 5,450,490; 5,574,962; and 5,581,800, which are hereby incorporated by reference. Other ways of embedding the code in the broadcast and decoding the embedded code will be known to those skilled in the art and are within the scope of the present invention.

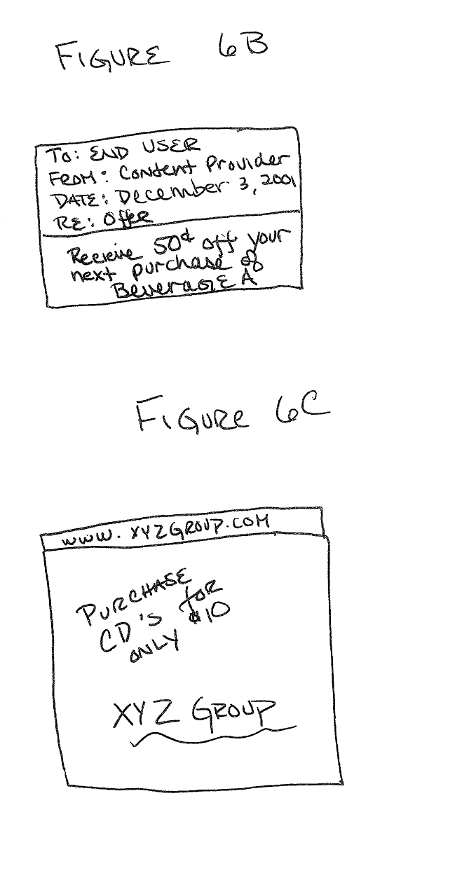

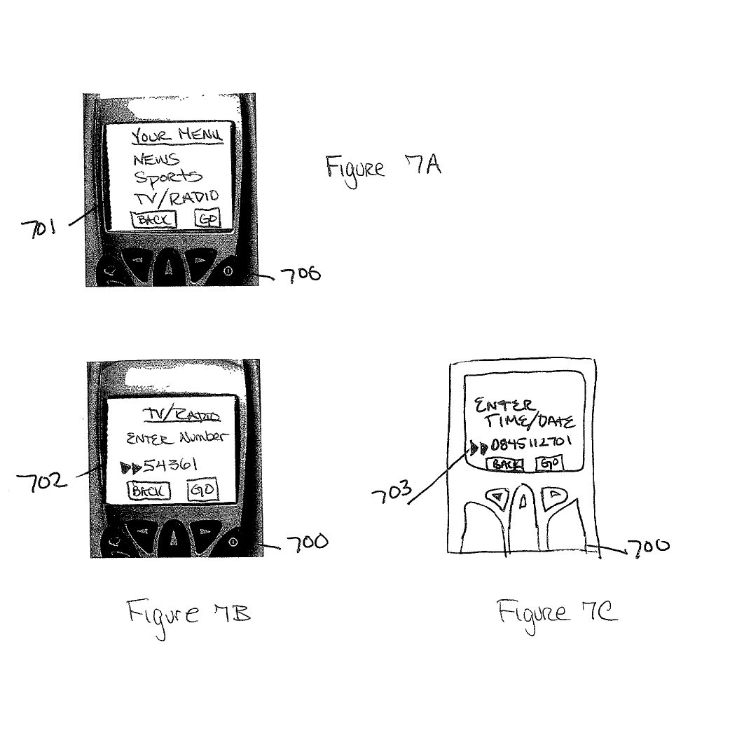

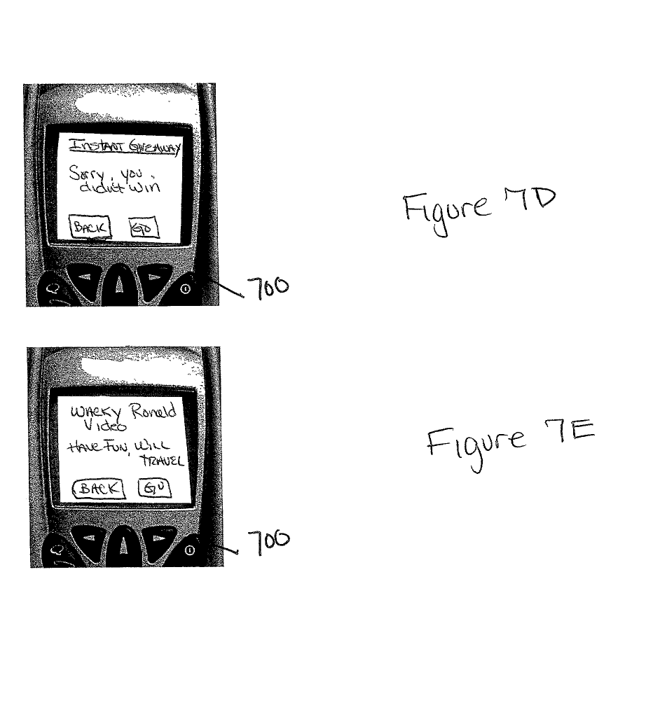

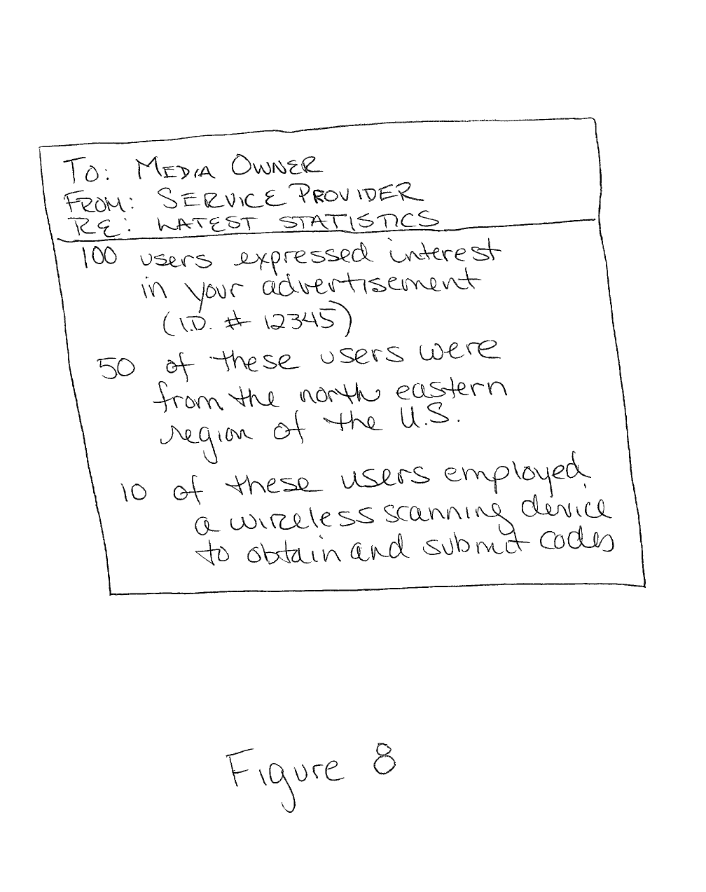

Once the code is captured, it may be transmitted to the platform 100 automatically (either immediately upon decoding or at a preset time) or stored on the device and transmitted to the platform 100 at a later time. As in the embodiment using visible and audible codes, the time/date information is, in the preferred embodiment, captured automatically along with the code. In other embodiments, the time/date information is inputted by the end user manually or a time date stamp feature of the input device may be employed. The time date information is stored at platform 100 and associated with the corresponding code information. In the event an end user does not include time date information for a particular code, the user will be prompted to enter the time date information, using, for example, screen 600 shown in FIG. 6A or as illustrated in FIG. 7C.

The devices that may be used in accordance with the present invention include, but are not limited to, mobile phones, PDAs, remote controls (with a time stamp feature and the ability to connect to an Internet-enabled device) and personal computers. Any device that is capable of accepting codes and time/date information, and communicating such information to a server 150 over the Internet 50 (either directly or through an Internet-enabled device), can be used in connection with the present invention. Such device would also be required to have, in the preferred embodiment, audio input capability, a sufficient amount of processing power, and a real time clock.

Upon submitting the code to the platform 100, the platform 100 identifies the broadcaster corresponding to the code. In particular, a registry of broadcasters along with their corresponding unique codes is maintained in either of databases 102 or 103. By way of example, FIG. 2 illustrates a preferred embodiment of a data structure that may be used to organize a registry that identifies broadcasters 203 and their corresponding codes 202.

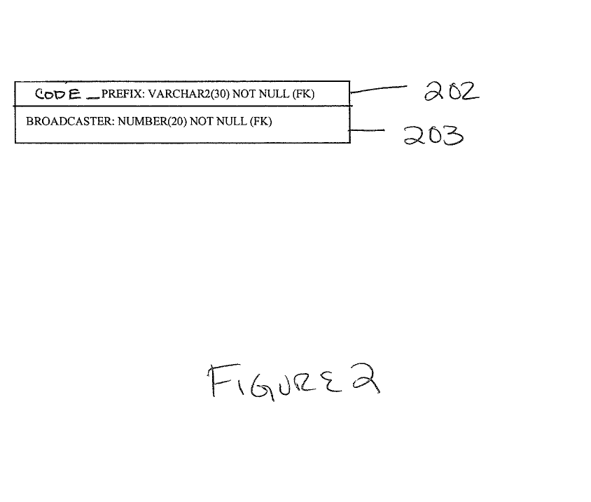

In addition, a programming sequence database for each broadcaster is maintained, for example, in database 104. The programming sequence database includes broadcast content information (e.g. advertisements) organized in time sequence for each broadcaster. FIG. 3 illustrates a preferred embodiment of a data structure that may be used to organize programming sequence information for each broadcaster. For each broadcaster, and for a given time and date (identified in time range field 302), the identity of the media owner (media owner field 304) (i.e. an advertiser) and an identification number of the media owner (media number field 306) broadcasting the content can be determined. In some embodiments, a code and symbology (code 310 and symbology 312) may be provided as additional identifying attributes of the media owner. Zip code information (station zips field 314) may also be used, in some embodiments, to assist in identifying the appropriate broadcast station data table 300 for a broadcaster in a given zip code. Thus, for example, the programming sequence database may store information that a particular fast food company (i.e. the media owner) broadcast content at 12:03:33 EST, Oct. 17, 2001 (i.e. the time/date information), on Philadelphia (identified by the zip code) Channel 67 (i.e. the broadcaster).

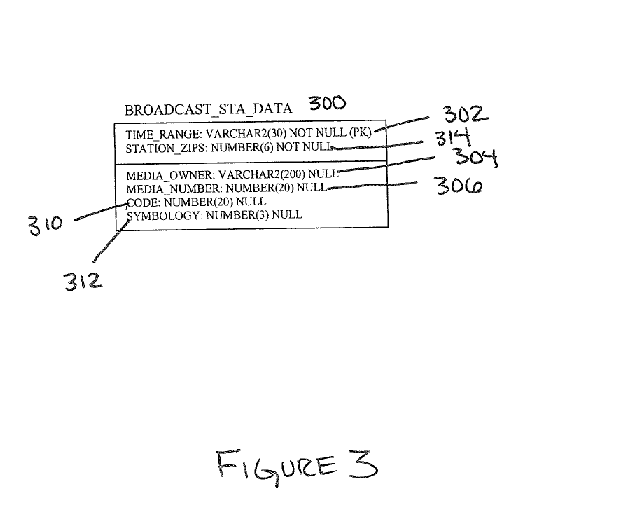

Based on the media owner and identification number identified from the programming sequence database, an application database (e.g., maintained in either of databases 102 or 103) may be consulted to determine the application to which the end user should be connected. FIG. 4A illustrates a preferred embodiment of a data structure that may be used to organize an application database. For example, for a given media owner 304 and media number 306 identified in broadcast station data table 300, an application (media title 404 and media content 402) may be identified. In alternative embodiments (shown in parentheses in FIG. 4A), for a given code 310 and symbology 312, an application (media title 404 and media content 402) may be identified. The end user is then connected to the identified application (e.g., an offer to download a song heard on the radio, an offer to buy an advertised compact disc, an offer to have e-mailed to the end user a recipe prepared during a television show).

In some embodiments, the code inputted or captured may identify the application (i.e., media title 404 and media content 402) directly from the application database using code 310 and symbology 312.

In other embodiments, the application identified may be based, at least in part, on end-user information. For example, an end user may register with platform 100 and indicate a particular zip code in which the end user lives, as shown with reference to FIG. 1B. Thus, when the end user enters a code associated with a broadcaster (e.g., Channel 6), the system will select the particular broadcast station data table for the end user's locale identified by the zip code 314 in programming sequence database 300. By way of further example, upon registering with platform 100, the end user may have indicated that he wishes not to receive any applications that relate to contests. This user preference will be maintained in database 102 and will be consulted prior to sending this end user applications.

Broadcasters 128 are, in the preferred embodiment, responsible for maintaining programming sequence information in, for example, database 104. Third party service providers 400 (e.g. media owners) are, in the preferred embodiment, responsible for providing information to be included in the application database. Where the application database is maintained on platform 100, third party service providers 400 may access databases 102, and manipulate the data therein, through hub site 101. For example, with reference to FIG. 4B, a media owner may register with the hub site 101 using screen 450. In particular, the media owner will include the name of its company and its identification number (to be included, for example, in the media owner 304 and identification number 306 fields of broadcast station data table 300). Other information, such as the name and contact information of the administrator for the registering media owner may be included. With reference to FIG. 4C, the media owner may use screen 460 to identify an application in advanced service URL area 461 (i.e. stored in application 402 field of the table illustrated in FIG. 4A) for a particular service name 462 (i.e. stored in title 308 field of the table illustrated in FIG. 4A). A default display name for the application may also be indicated in display name area 463.

In a particular example employing the present invention, an end user 500 obtains using his device code and time/date information using any one of a number of different methods. For example, with reference to FIGS. 5A through 5I, the user may know the code associated with a broadcast prompt 520 identifying a broadcaster displayed visually on television (FIG. 5A) or broadcast audibly on television (FIG. 5E), or may know the code associated with the audible identification of a radio station broadcast on the radio (FIGS. 5B and 5D). The code itself may be broadcast on television visually (FIG. 5C) or audibly (FIG. 5G), or audibly on the radio (FIG. 5F). In still another example, with reference to FIG. 5H, neither the code nor any information or prompt indicating the code is broadcast from the television (or radio), yet the end user knows the code associated with the station. In further embodiments, a broadcast prompt 520 (FIG. 5A), which could be any icon, symbol, trademark, logo or other indicator, or a bar code 521 (FIG. 5I) could be captured by the user employing, for example, an optical scanner using CCD arrays.

The codes and time/date information are then uploaded to platform 100 via hub site 101 using a workstation or other device connected to the Internet. The codes may be uploaded automatically, for example, upon input if the input device is Internet-enabled and connected. The codes may also be uploaded automatically upon synching the device in which the codes are stored with an Internet-enabled device and navigating to the hub site 101. Regardless of the type of upload procedure, the uploaded codes are stored, in the preferred embodiment, in platform 100. In the preferred embodiment, each code is resolved to identify its corresponding broadcasters (from broadcaster database illustrated with reference to FIG. 2) and the broadcast content is identified (from programming sequence database illustrated with reference to FIG. 3) automatically upon uploading.

With reference to FIG. 6A, screen 600 displays a list, in column 601, of broadcast content identified based on codes and time/date information inputted by an end user. For example, content item 603 indicates that an advertisement for Beverage A was broadcast on the station identified by the code inputted or captured by end user at the time and on the date (indicated in column 602) inputted or captured by the end user. For each content item, the end user may then select and launch a service to process the content item using dialog box 604. Upon launching the service, application database (illustrated with reference to FIG. 4) is consulted to determine the application that is to be presented to the end user for the particular content item identified. In one example, it is determined from application database that the end user is to be sent an electronic mail message containing a coupon that can be used for his next purchase of Beverage A, as shown in FIG. 6B. Launching the application in dialog box 604 for content item 605 (a compact disc for recording artists XYZ Group) shown in FIG. 6A, will result in the presentation to the end user of a destination selected by the media owner. For example, if the destination is a web page and the end user is using a PC, a new browser window may open with the destination already loaded, as shown, for example, in FIG. 6C, where the end user can purchase the compact disc. In another example, where the destination is streaming video, the video would begin playing upon launching the application.

In still another example, the end user may be listening to a radio station or television broadcast wherein she hears, for example, a song or a television show of which she would like to own a recording. In this case, the end user may dial into a telephone system associated with the platform 100 and speak the broadcast code associated with the radio or television station along with the words “buy recording”. The inventive system would consult databases 102 or 103 to determine the broadcaster first. Then, using the appropriate programming sequence database for the identified broadcaster and based on the time the end user placed the call, the media owner and media number of the song or television show being broadcast at that time can be identified. Next, the application database is consulted to determine the application associated with that media owner and media number. In this case, the application is an offer to purchase a recording. The end user has already indicated her intent to purchase (which the system has identified using voice recognition) and, thus, the recording is purchased automatically for the end user. As with other embodiments described herein that use voice recognition, in the event that the voice recognition system is unable to interpret the end user's voice input, in one embodiment, an error message is generated. In other embodiments, a notice may be sent to the media owner, informing the media owner of the end user's failed attempt to employ the inventive system.

With reference to FIGS. 7A through 7E, an example of the manner in which an end user may interact with platform 100 using a mobile telephone 700 with a live Internet connection is shown. In this example, with reference to FIG. 7A, end user 500 using mobile telephone 700 selects a service of interest to the end user (in this case, service 701, which allows for the processing of codes and time/date information associated with a broadcast). Upon selecting service 701, the end user 500 is connected to the hub site 101. The end user then enters the code information 702 associated with a broadcast to which the end user is exposed, as illustrated in FIG. 7B. In this case, the user is watching television station LMN for which the code is 54361. The user then employs the time/date stamp feature on the mobile telephone 700 or enters the time and date information 703 on the mobile telephone 700, as shown in FIG. 7C, and depresses the key on his mobile telephone 700 associated with the “go” command. In some cases, the device captures the time and date automatically at the same time it captures the code, thereby not requiring any manual input by the end user.

Using broadcaster database, platform 100 identifies the broadcaster associated with code 54361 (in this case, television station LMN). Using programming sequence database, based on the broadcaster identified and the time/date information inputted by the end user, the media owner and title of the content item is identified. In this case, the content item is a fast food restaurant advertisement. Then, platform 100 uses application database to determine the particular application to be presented to the end user for the content item. In this example, the application involved a contest. The end user 500 was entered in the contest simply by expressing interest in the fast food restaurant advertisement and, as shown in FIG. 7D, is informed that he did not win the contest. In another example, with reference to FIG. 7E, the application involves allowing the end user to review a short streaming video related to the fast food restaurant over the mobile telephone 700.

In still another example, the system allows an end user to record a movie or show broadcast on the television. In one embodiment, the end user identifies the broadcast she wishes to record by entering or capturing a code that corresponds to a particular broadcast as well as initiating a command to record the broadcast. In another embodiment, the code inputted by the end user is a VCR+ number uniquely identifying a particular show (found in a television guide, for example). Upon entering the VCR+ number, the particular show is identified from databases 102 or 103, and presented to the end user with an option to record the show. In yet another embodiment, the end user inputs or captures on a device code information corresponding to the broadcaster that is broadcasting the movie or show. The end user further inputs or captures on the device time/date information corresponding to the time and date the movie is being broadcast. From this information, the movie that is being broadcast can be identified using, for example, databases organized as shown in FIGS. 2 and 3. In addition to the code and time/date information, the end user inputs a command indicating his desire to record the movie.

Upon identifying the movie or show the end user wishes to record, platform 100 transfers the data to a personal video system 560 (shown in FIG. 1) connected to the end user's television 562, instructing the system 560 to record the movie or show. Personal video system 560 may include any device that is capable of recording media and that can send and receive commands to and from platform 100 via the Internet 50.

As a service to third party content providers 400, platform 100 may track end users 500 who access each application. In particular, platform 100 may maintain information regarding end users (e.g., their names, preferred languages, locales, preferred contact paths, and confidential information) and their activities (e.g., which codes were entered, when and how; which products were searched; and which services were selected). A detailed description of how such information may be maintained can be found in co-pending U.S. patent application Ser. Nos. 09//971,115; 09/971,321; 09/971,369; and 09/971,093, which are hereby incorporated by reference. This tracking feature would be very advantageous and valuable to advertisers. Typically, advertisers purchase advertising time from broadcasters in blocks, rather than specific time slots. Thus, the advertiser does not know with any specificity when their advertisements were broadcast. Through the inventive system, the advertisers can learn the time that their advertisements were run using the information maintained in, for example, broadcast station data table 300. FIG. 8, illustrates an example of the way in which end-user tracking information can be made available to the media owner (e.g., via electronic mail, on a web site etc.).

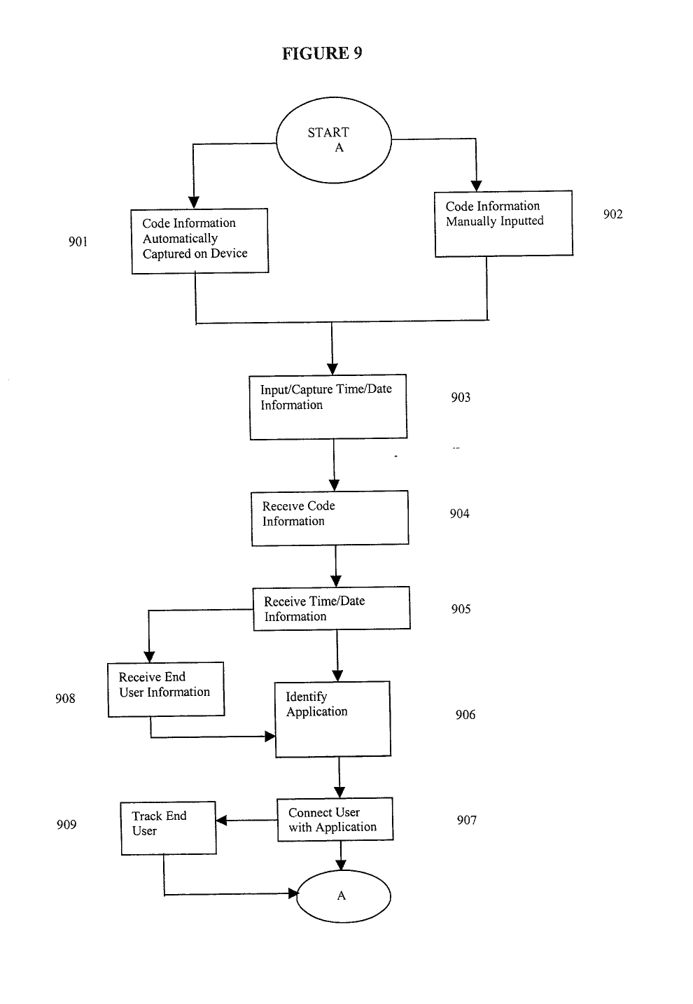

With reference to FIG. 9, a method of connecting at least one end user to a content provider application relating to a broadcast (e.g., TV or radio) is illustrated. The broadcast may be adapted to include a code, may include a broadcast prompt associated with a code, or may be associated with a broadcaster that is associated with a code. In step 902, code information associated with a code that uniquely identifies a broadcast station is input into a device manually by an end user. In an alternative embodiment, in step 901, the code information is automatically captured on the device by the end user (where, for example, the code is not detectable by a human either audibly or visually). In step 903, in some embodiments, time date information corresponding to the time and date of the broadcast is inputted by the end user or automatically captured. In step 904, the code information is received at the hub site. In step 905, the time/date information is received at the hub site, in embodiments where time/date information is required. In step 906, the application is identified based on the received code information and, in some embodiments, time date information. In step 907, the end user is connected with the identified application. In some embodiments, the code information and time date information are received in the same step and, thus, steps 904 and 905 will be combined into a single step.

In another embodiment, end user identification information (for example, a zip code or application preferences) is received, in step 908, at the hub site. In this embodiment, the application identified in step 906 is further based on the end user identification information.

In step 909, in some embodiments, one or more of the end users from whom the code information is received may be tracked. Among other uses, the tracking ability provides the content providers with the ability to track the use of certain applications by certain users for the purpose of targeting end users with coupons, promotions, videos, interactive demos, or other content-specific information.

Although the foregoing description is directed to the preferred embodiments of the invention, it is noted that other variations and modifications will be apparent to those skilled in the art, and may be made without departing from the spirit or scope of the invention.

What is claimed is:

1. In a system having a plurality of end users that remotely access a network having at least a hub site and a content provider site, a method of connecting at least one of the end users to a content provider application relating to a broadcast adapted to include a code, comprising:
receiving, at the hub site, code information associated with the code that uniquely identifies a broadcast station;
receiving, at the hub site, time date information corresponding to a time and a date of the broadcast;
based on the received code information and the received time date information, identifying the application; and
connecting the end user with the identified application.

2. The method of claim 1 further comprising:
receiving, at the hub site, end user identification information, wherein identifying the application is further based on the end user identification information.

3. The method of claim 1 wherein the received code information is inputted manually using a device connected to the hub site via a global communications network.

4. The method of claim 1 wherein the received code information is automatically captured on a device connected to the hub site via a global communications network.

5. The method of claim 1 wherein the broadcast is a radio broadcast.

6. The method of claim 1 wherein the broadcast is a television broadcast.

7. The method of claim 1 wherein the code is detectable within the human-audible spectrum of the broadcast.

8. The method of claim 1 wherein the code is detectable outside the human-audible spectrum.

9. The method of claim 1 further comprising:
tracking one or more of the end users from whom the code information is received.

10. The method of claim 1 wherein the application comprises interactive content.

11. The method of claim 10 wherein the interactive content comprises an offer to record the broadcast.

12. The method of claim 1 wherein the application comprises an electronic mail message.

13. The method of claim 12 wherein the electronic mail message comprises promotional materials.

14. The method of claim 1 wherein the code information is further associated with a broadcast prompt.

15. The method of claim 14 wherein the broadcast prompt comprises a human viewable indicator.

16. The method of claim 14 wherein the broadcast prompt comprises a human audible indicator.

17. In a system having a plurality of end users that remotely access a network having at least a hub site and a content provider site, a method of connecting at least one of the end users with a content provider application relating to a broadcast comprising:
receiving, at the hub site, code information associated with a broadcast prompt included in the broadcast, the code information uniquely identifying a broadcast station;
receiving, at the hub site, time date information corresponding to a time and a date of the broadcast;
based on the received code information and the received time date information, identifying the application; and
connecting the end user with the identified application.

18. The method of claim 17 wherein the broadcast prompt comprises a human viewable indicator.

19. The method of claim 18 wherein the broadcast prompt comprises a human audible indicator.

20. In a system having a plurality of end users that remotely access a network having at least a hub site and a content provider site, a method of connecting at least one of the end users with a content provider application relating to a broadcast on a broadcast station, comprising:
receiving, at the hub site, code information associated with the broadcaster which uniquely identifies the broadcast station;
receiving, at the hub site, time date information corresponding to a time and a date of the broadcast;
based on the received code information and the received time date information, identifying the application; and
connecting the end user with the identified application.

21. A system for connecting an end user to a content provider application relating to a broadcast adapted to include a code, comprising:
a network that is accessed remotely by a plurality of end users, the network comprising
at least one content provider site that hosts the application;
at least one hub site that receives code information associated with the code that uniquely identifies a broadcast station; receives time date information corresponding to a time and a date of the broadcast; based on the received code information and the received time date information, identifies the application; and connects the end user with the identified application.

22. The system of claim 21 further comprising a user device for communicating with the hub site.

23. The system of claim 22 wherein the application is deliverable to the end user via the user device.

24. A system for connecting an end user to a content provider application relating to a broadcast, comprising:
a network that is accessed remotely by a plurality of end users, the network comprising
at least one content provider site that hosts the application;
at least one hub site that receives code information associated with a broadcast prompt included in the broadcast, the code information uniquely identifying a broadcast station; receives time date information corresponding to a time and a date of the broadcast; based on the received code information and the received time date information, identifies the application; and connects the end user with the identified application.

26. A system for connecting an end user to a content provider application relating to a broadcast on a broadcast station, comprising:
a network that is accessed remotely by a plurality of end users, the network comprising
at least one content provider site that hosts the application;
at least one hub site that receives code information associated with the broadcaster that uniquely identifies the broadcast station; receives time date information corresponding to a time and a date of the broadcast; based on the received code information and the received time date information, identifies the application; and connects the end user with the identified application.

27. In a system having a plurality of end users that remotely access a network having at least a hub site, a method of connecting at least one of the end users with a content provider application relating to content broadcast on a broadcast station, comprising:
receiving, at the hub site, code information that uniquely identifies the broadcast content;
based on the received code information, identifying the application; and
connecting the end user with the identified application.
